(19) United States
(12) Patent Application Publication
(10) Pub. No.: US 2009/0249085 A1
(43) Pub. Date: Oct. 1, 2009

(54) Security module and personalization method for such a security module

(75) Inventor: Philippe Stransky, (US)

Correspondence Address: HARNESS, DICKEY & PIERCE, P.L.C., P.O. BOX 8910, RESTON, VA, 20195, US

(73) Assignee: NagraCard S.A.

(21) Appl. No.: 12/457,275

(22) Filed: Jun. 5, 2009

Related U.S. Application Data
(63) Continuation-in-part of application No. 11/166,126, filed on Jun. 27, 2005.

(30) Foreign Application Priority Data
Jun. 29, 2004 (EP) 04103053.7

(51) Int. Cl. G06F 21/00

(52) U.S. Cl. 713/194

(57) ABSTRACT

This invention relates to a security module comprising a microprocessor, a program memory containing at least one operating program and unique identification means of said module. This security module is characterized in that the identification means are constituted by a set of unique and artificial computer codes, compatible with their execution by said microprocessor of the module and stored in the program memory.

The invention also concerns a personalization method of a security module by a unique identifier, this module comprising a microprocessor and a program memory containing at least one operating program. The method of the invention is characterized in that it includes the steps of generation of a unique set of computer codes, called artificial computer codes and the writing of this set of codes in the program memory in specific memory locations.

This application is a Continuation-In-Part of U.S. patent application Ser. No. 11/166,126, the entire contents of which are incorporated herein by reference.

The present invention relates to the domain of secured security modules comprising at least one microprocessor and a program memory. The invention also concerns the personalization of such a security module as well as the identification of a security module whose content have been made public.

These security modules are used in systems activating cryptographic operations and are delivered in mono-block form. They are produced on a single silicon chip, either assembled on a support and embedded in a resin or protected by a sheet covering the different elements and acting as a fuse in the case of an attempt of intrusion.

These secured modules have a program memory containing in particular a start-up program and one or more operating programs. The start-up program is executed at the time of activation of the processor or at each reset. This start-up programme is stored in a ROM type memory, that is to say that it is read-only access.

The operating program is stored in a rewritable type memory, usually of the EEPROM, NVRAM or Flash type.

When the start-up program has completed its verification, it starts the execution of the operating program at a predefined address.

One of the known attacks to discover the content of the memory of a security module is to search for a security leak such as a memory overflow that allows taking control of the processor. Once this control has been taken, it is possible to transfer the content of the memory towards the exterior and to analyse the security mechanism and the keys used.

From the knowledge of the memory content it is possible to obtain the keys serving to manage the different rights and to access the services that are controlled by the processor. Thus, if a change of keys occurs, ordered by the management centre, this change command will be encrypted by a key present in the program memory. By having this key, it is possible to decrypt the key change message and also to update the content of this new key.

It is thus noted that when the security of a security module has been violated once by a malicious individual, all the changes initiated by the management centre are ineffective with respect to security since the change means (new transmission key, for example) use the keys that this individual already has in his/her possession. This individual can thus decrypt the updating message and also change its transmission key.

When the security of a security module has been violated and the content of the program memory is thus discovered, the malicious individual who has violated the security of this module may publish the computer codes corresponding to the content of the program memory, this publication in particular being made on a network such as the Internet. This allows third parties, having blank cards, to copy these codes and in this way to create perfectly functional clone cards in a completely illegal way.

One of the means to limit these illegal activities consists in increasing the security of the modules in such a way that it is particularly difficult to violate the security of this module.

Another means to limit strongly these illegal activities consists in detecting the security module in which the security has been violated and that has allowed cloning and consists in acting on this module by deactivating this module and the clones that the module has allowed to produce.

The document U.S. Pat. No. 6,725,374 describes a security module using the first means mentioned above, namely the improvement of security with reference to the previous modules. In fact, in the module described in this patent, the discovery of keys is made more difficult thanks to the addition, in the computer code of the module, of “scrambling” elements that scramble data which can be used to extract the keys, namely electric consumption. These scrambling elements are made up of modules in which the execution order is of no importance to the development of the program. These elements are used randomly in such a way that the processing of two identical input signals does not produce two identical output signals. If, despite this additional difficulty, a person is able to determine the content of the security module, this code can be published and reused by third parties, without the possibility to find the source of the published code.

This invention proposes the use of the second means mentioned above, that is to say that it proposes the introduction of means into the module that allow the detection of the module that has been used for a fraudulent action.

As it is well known, each security module includes a unique identification number. In general, the individuals able to extract the computer codes of a security module are also able to detect the unique number of their module, starting from a relatively brief analysis of the content of this module. This unique number is not published at the time of the publication of the computer codes.

On one hand this prevents the malicious individual from being identified and on the other hand the deactivation of the original module and its clones.

The aim of this invention is to propose a method and a security module comprising identification means of the security module at the time of the illegal publication of the code of this module, even if the malicious third party has withdrawn the identifier of this module. In this invention, the fight against security module cloning does not thus consist in improving the security of these modules, but rather in facilitating the detection of the modules that have been used for cloning in such a way as to render these modules inoperative.

The European patent EP 1 178 406 describes a process in which a unique serial number of a printed circuit is stored in a memory. In this invention, the serial number is first read from a bar code and then converted into digital data. This data is possibly enciphered before being introduced into one or more memories. On one hand the aim of the invention is to make detection of the serial number difficult and on the other hand to prevent an unauthorised person from discovering and modifying this serial number. In order to conceal the serial number, the latter is stored in a large memory in such a way that it is difficult to locate among all the other stored data. In order to prevent the discovery and modification of the number, the latter is enciphered.

The fact that the serial number is hidden fails to provide a satisfactory resolution to the problem of the invention. In fact, the serial number is stored in the form of a value in a given location of the memory. If a person or a group of people discover the location of the serial number, this location may be rendered public. At the time of the publication of the computer code necessary to produce a cloned security module, it will be sufficient to avoid the publication of the content of this location in order to avoid the security module from being detected.

The aim of the invention is achieved through a security module comprising a microprocessor, a program memory containing at least one operating program and unique identification means of said module, characterized in that these identification means are constituted by a set of artificial computer codes, compatible with its execution by said microprocessor of the module and stored in the program memory.

This aim is also achieved through a personalization method of a security module by a unique identifier, this module comprising a microprocessor and a program memory containing at least one operating program, characterized in that it includes the following steps:
generation of a unique set of computer codes, called artificial computer codes,
writing of this set of codes in the program memory in specific memory locations.

The aim of the invention is also achieved through an identification method of a security module as defined previously and in which the computer codes have been made accessible to the public, this process including the steps of:
extracting the artificial computer codes from among the computer codes made accessible to the public;
processing said artificial computer codes according to predefined rules in such a way as to deduce the identification means of said security module.

The principal advantage of the personalization method of the invention is that the artificial computer codes are considered by a malicious third party as being part of the program and thus seem necessary for the reproduction of a clone module.

These artificial computer codes are embedded in the operating program so that it is difficult to locate the data that is actually necessary for the correct operation of the module and the data that is used to generate the identification number.

According to a specific embodiment, it is possible to deny access to a security module that does not contain a correct identification means. This forces on one hand, a fraudulent user to introduce an identification means and on the other hand, this also forces a hacker to publish this identification means.

The security module according to the invention and the associated method incite a malicious individual who has published the computer codes of a pirate security module also to publish the data that allows the determination of the number or a unique identification number of the security module. Thanks to this, it is relatively easy to determine the origin of the original security module. From here, there are methods that render inoperative this original module as well as the clones that it allowed to produce. One of these methods, for example, is described in European Patent Application EP 04100969.7 assigned to the same assignee.

According to different embodiments of this invention, the data used to generate the identification number or identification means can be static or dynamic. In the static embodiment the data can be introduced at the moment of the manufacturing of the module, at the moment of the personalization or at the first use for example.

In the dynamic embodiment, the data used for generating the identification number can be sent to the user unit at each switching on, at regular or irregular intervals, or according to various criteria that can depend on the management unit and/or from parameters of the user unit.

According to a specific embodiment of the dynamic version, the artificial computer code is not persistent and a device not connected does not contain the useful information.

The invention will be better understood thanks to the following detailed description that refers to the enclosed drawings that are given as a non-limitative example, in which:

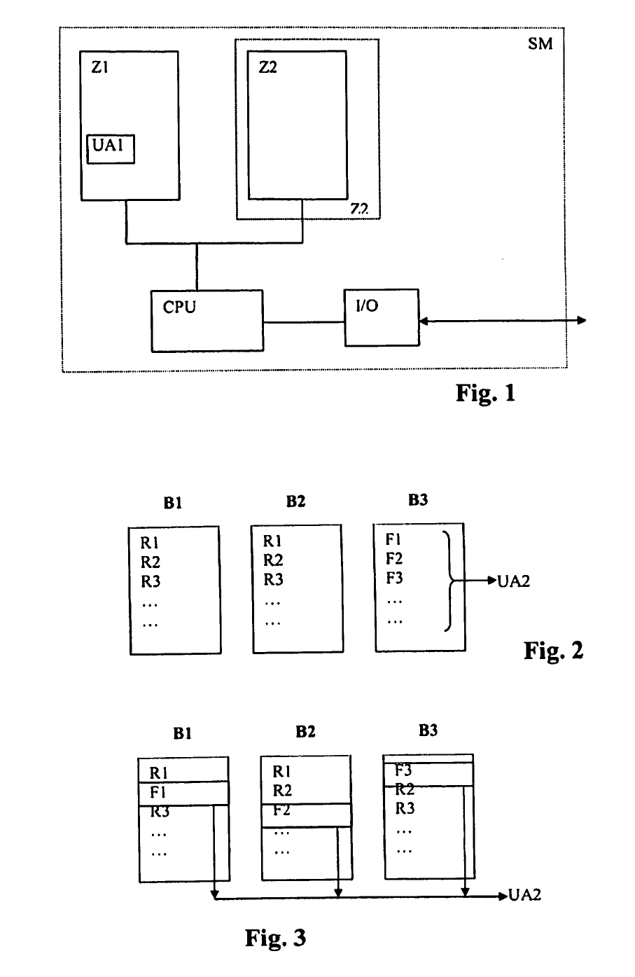

FIG. 1 shows generally a security module according to this invention;

FIG. 2 represents a first embodiment of a part of the security module in FIG. 1;

FIG. 3 shows a second embodiment of the security module in FIG. 1; and

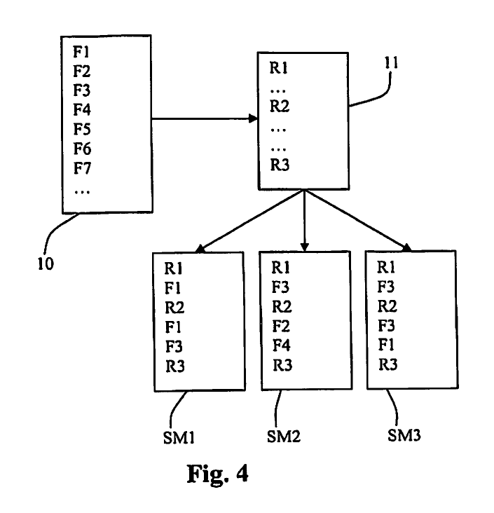

FIG. 4 shows a particular embodiment of the method of the invention.

With reference to FIG. 1, the security module SM is a secure processor module. For this reason, it has at least one microprocessor CPU and a program memory containing in particular an operating program. In the embodiment represented, the program memory contains a first start-up area Z1 and a second area Z2 called a work area. The first start-up area is constituted by all or part of a ROM memory that is thus non-rewritable. It is possible that one part comprises memory spaces in RAM or EEPROM for the variables among others. It is called “start-up” due to the fact that it is the first to be executed at the time of the power up of the security module.

Conventionally, the security module can contain a unique identification number UA1 that can be stored in a read-only memory area. This number UA1 is generally accessible to the user in the form of a serial number that can be printed on the security module itself or on enclosed documentation, for example.

The work area Z2 contains the operating program and the data. This area is constituted by a non-volatile memory, but with a writing possibility such as EEPROM. Area Z2 can also contain a volatile memory such as a RAM. In fact, this area is generally not homogeneous and can comprise several memory types such as ROM, RAM, EEPROM, NVRAM or Flash.

The microprocessor CPU is automatically directed in the first area Z1 during a switch on or restart (reset). This is where the first security operations are executed. These operations use the first memory area, but also work area Z2 if necessary.

In FIG. 1, the I/O block shows the communication means towards the exterior of the module SM, said means being indispensable for the use of the cryptographic functions and the rights stored in the memory. It is also through this way that data is accidentally extracted from area Z2 by a security leak such as described above.

As previously indicated, the work area Z2 contains the operating program intended for the operation of the module. Some parts of the operating program can be stored in a non volatile memory and some parts may be stored in a volatile memory. In this case, the part of the program stored in the volatile memory must be sent when the security module is powered up. According to this embodiment, when the module is switched on, it is not immediately able to process data. It must first receive the artificial code, priori to being able to work. This artificial code can be sent for example in an Entitlement Management message EMM to a specific user, to a group of users or to all the users attached to a management center.

In this dynamic mode, the content of the EMM could be an algorithm used to generate the artificial code instead of the artificial code itself. This algorithm could use a data pertaining to the user unit, for example a MAC address. In this case, a unit connected with another MAC address would not work.

One embodiment of the operating program structure is shown in a detailed way in FIGS. 2 and 3. This operating program is made up of computer codes that can be represented in the form of instruction lines that have determined functions if placed before the compilation of this type of program.

For the clarity of the description, it is supposed that the instructions are divided into instruction blocks with references B1, B2, B3, which respond to a given syntax.

In the module of the invention, at least two types of instruction lines coexist. The first type corresponds to conventional instructions called real lines that are executed by the microprocessor according to defined criteria that produce a “useful” result for the operation of the program. The second type of instructions are instructions that are not actually executed by the microprocessor and/or that do not directly produce any result. These instruction lines, called artificial lines hereinafter, are on the contrary used to form unique identification means UA2 associated with the security module in question. In fact, the artificial lines can either be instructions that are not executed by the microprocessor, or instructions that are actually executed but that do not produce any result that influences the development of the operating program. In other words, the operating of the program is the same, whether these codes are present or not. The terms “artificial codes” or “artificial lines” must be considered as covering these two embodiments.

With reference more particularly to the embodiment disclosed in FIG. 2, the operating program includes a certain number of real instruction blocks B1, B2, that can form program routines, as well as a set of artificial computer codes, forming an instruction block B3 that has the same appearance as a conventional instructions block but which is nevertheless different for each security module. These computer codes are compatible for an execution by the microprocessor and respond to the syntax of said microprocessor so that it is not possible, by means of a simple code analysis, to locate the real codes that will be executed and the artificial codes that will not be executed or that will not have any effect on the operating program. The instructions that contain this artificial set are artificial lines that are not generally executed by the microprocessor or their execution does not influence the operation of the programme; they are used to form the unique identification means UA2 of the module. The real instructions are made up of real lines indicated by R in the FIGS. 2 and 3 and the artificial lines are represented by references F in these Figures. This instruction block B3 can preferably be inserted into the operating program for improved concealment. The artificial computer codes serving to form the identification means can also contain registration values or variables, for example.

It should be noted that it is possible to use artificial code that are used to form the identification number, but whose result depends on the network they are connected to. In this case, if a clone security module is connected to another network than the one to which the original security module is connected, the identification number could be different and could for example prevent the security module from working.

According to the embodiment shown by FIG. 3, the security module comprises, contrary to the previous example in which the artificial lines are grouped together in the memory of the operating program, a certain number of artificial instruction lines F, divided among the real instructions R. These artificial lines form a set of computer codes that are unique and different for each security module.

Generally, in view of the fact that the instruction lines are executed consecutively, it is important that these instruction lines are not executed or that their execution does not affect the correct development of the operating program. It is also important that these specific computer codes are not detected by a malicious individual.

In order to reconcile these constraints, several embodiments are available. In one of the embodiments, the artificial lines include a specific data indicating that the line in question is artificial and must not therefore be executed by the microprocessor.

According to another embodiment, certain real instructions contain indications related to the location of the artificial lines. This type of indication can, for example, be made in the form of an instruction indicating that a line placed in a determined memory location must not be processed.

The instructions that consist of not processing the artificial lines can be concealed, for example, by indicating that the line in question must only be skipped if a condition is fulfilled. It is then possible to arrange that this condition is always fulfilled. It is also possible to add to a real line, an indication according to which the following line is artificial.

According to another embodiment, nothing in the computer codes can distinguish an artificial line from a real line. The security module contains a stored data indicating the location of the computer codes that the microprocessor must not execute.

An alternative such as that briefly mentioned previously can also consist in using an instruction as an artificial line that is actually executed by the microprocessor but that has no effect on the following execution of the program. This type of instruction could be an indication that the program must pass to the following line. Of course, it is possible to make this type of “useless” instruction difficult to locate, for example, by writing the instruction in the form of a conditional skip, by indicating that the passage to the following line must only be made if a determined condition is fulfilled, while ensuring that this condition is always fulfilled. Another form consists in sending the program to a predetermined address whenever a condition is fulfilled, while ensuring that this condition will never be fulfilled. Another form consists in modifying a memory location that is known to be without importance. These “useless” instructions are indicated in the text as “having no influence on the execution by the microprocessor of the operating program”, as these instructions can be suppressed without the result of the execution of the operating program being affected.

A particularly well-adapted way to make the detection of artificial lines by a malicious individual difficult is obfuscation or concealment, a process which consists of rendering particularly complex the comprehension of a decompiled computer code.

According to one alternative of the invention, it is also possible for only one part of the artificial lines to serve as the identification of the security module. The artificial lines that do not serve to identify the security module are only present to complicate the comprehension of the computer code and to prevent a pirate from detecting the data that must be published to produce a functional clone as well as the data that must be omitted if the unique identification number of its security module must remain undisclosed.

Such artificial supplementary lines can also be introduced into the embodiment in which the module comprises an artificial block in which the instructions are disseminated in the real instructions.

It should be noted that both embodiments, namely that disclosed in FIG. 2 and that disclosed in FIG. 3 can also be combined, that is to say that the artificial instructions can be introduced into a determined block, while other artificial instructions are further divided among the real instructions.

It is also possible to generate more than one identification means or to introduce data that allows the generation of the same unique identification means UA2 several times, so that even if certain artificial lines are detected and are not published, it is still possible to determine the identification means UA2.

The realisation of the security module according to the invention includes a personalization phase in which data specific to the module is introduced. The invention is also associated to a detection step of a module whose computer codes have been published. This detection step consists in extracting, from published data, the data specific to the security module.

The personalization method according to the invention essentially consists of generating a set of unique computer codes and then writing these codes in the program memory.

In the first place, this personalization method depends on the security module type chosen and more particularly on the location of the artificial computer codes. In fact, when the artificial codes are arranged in the program memory in the form of separated block, the artificial codes can be generated in the form of a block and then introduced into the module.

When the artificial codes are dispersed in the real computer code, the real codes forming the operating program are stored in such a way that they include free locations. Artificial codes are then generated and inserted into these free locations.

In the embodiment in which the artificial codes are codes actually executed by the microprocessor, these codes however having no effect on the development of the operating program, it is possible to use a code directory. This directory contains a set of preset computer codes that do not influence the development of the operating program. These codes can be, as previously indicated, a conditional skip, the writing of a value in a memory area, the modification of a value or any other instruction which does not modify the development of the program whether the instruction is executed or not.

It is also possible to provide a process that automatically generates identification means from artificial codes contained in the directory. In fact, by knowing the number of free instruction lines and possibly the size of the blocks to be inserted, it is possible to obtain a certain number of codes from among the instructions of the library in such a way as to fill the blank lines of the operating program and in such a way that each security module uses a unique instructions set. This uniqueness can be made as well by the computer codes used as by the usage order of these codes. This process is schematically represented by FIG. 4 in which the reference 10 shows the directory of the artificial codes F1, F2, . . . The reference 11 represents the real computer codes R1, R2, . . . forming the operating program. These codes include empty memory locations.

At the time of the personalization of the security modules, a certain number of computer codes are selected from among the artificial codes stored in the directory in such a way that two security modules do not contain the same codes. These codes are introduced into the free memory locations of the operating program. In the example disclosed in FIG. 4, the artificial codes of the security modules having the references SM1, SM2 and SM3 are respectively the sets (F1, F1, F3), (F3, F2, F4) and (F3, F3, F1).

The personalization process can also have a step aiming to render the detection of the artificial computer codes more complex. In particular, when the artificial codes are grouped in a determined memory location in the form of a block, it is advisable to avoid the situation in which a simple comparison of the computer codes of two security modules in which the security has been violated allows a malicious individual to locate the artificial codes and thus avoiding their publication. In order to resolve this problem, an obfuscation or concealment stage is well suited.

The detection stage of a module in which the computer codes have been published such as mentioned above consists in extracting, from published data, the unique identification means of the security module, on one hand to possibly find the owner of the original module and on the other hand to render inoperative the module and the clones it has allowed to produce.

This detection step essentially consists of comparing the computer codes published with those that have been introduced into the security modules during the personalization phase. For this, different means are possible. In particular, a “line by line” comparison of published codes and of the generated codes is possible. Another way to carry out this comparison consists of extracting published codes and the artificial codes and then applying an operation to these artificial codes. A basic operation that is possible to carry out is the concatenation of the bits forming the artificial codes. Another operation can consist in determining a signature (hash) of the instruction block. In fact, every operation allowing obtaining a unique value from a unique instruction block can be used. This same operation is applied to computer codes generated during the personalization stage and then the unique values are compared.

The disseminated artificial instructions are processed as in the previous case, illustrated in FIG. 2, in such a way as to determine the unique identification means UA2 of the security module.

When the identification means of a security module in which the security has been violated have been determined, it is then possible to render inoperative the original security module as well as the modules cloned from this original module.

Other evident embodiment variants not described in detail above also form part of the invention. In particular, it is possible to introduce artificial computer codes allowing the generation of more than one identification means per security module. As an example, a first identification means could be constituted by a separated instruction block and another identification means by disseminated codes.

It is also possible to introduce redundant artificial codes so that the identification means can be extracted even if a part of the artificial codes is eliminated during publication.

It is possible that one identification means UA2 is not used for one unique security module but rather for a group of security modules. This is interesting in the case where the module group belongs to the same person or more generally to the same entity. A combination of the different embodiments above is also possible, that is to say for example that a security module can contain first identification means common to a module group and second identification means that are unique for each module.

The identification means UA2 can also be defined from computer codes representing values in a registered.

As a rule, provision is not made for the identification means UA2 to replace the identification number UA1 conventionally contained in a security module. The first identification number UA1 is present in the module and can, for example, be printed on the module if the latter is in the form of a smart card or a key, for example.

On the contrary, the identification means UA2 will be kept secret, as will the existence itself of a second identification number UA2.

1. Security module comprising a microprocessor, a program memory containing at least one operating program and a unique identifier of said module, wherein the unique identifier is constituted by a set of artificial computer codes executable by said microprocessor of the module and stored in the program memory.

2. Security module according to claim 1, wherein said computer codes are placed in a specific instruction block.

3. Security module according to claim 1, wherein said artificial computer codes are divided among the computer codes forming the operating program.

4. Security module according to claim 1, wherein said artificial computer codes are not executed by said microprocessor.

5. Security module according to claim 1, wherein said artificial computer codes do not modify the development of the operating program executed by said microprocessor.

6. Security module according to claim 1, wherein said module further includes a set of artificial computer codes that are not used for the operation of the security module, nor for the formation of the unique identifier.

7. Security module according to claim 1, wherein said artificial computer codes are stored in the program memory after the security module is switched on.

8. Personalization method of a security module by a unique identifier, the module comprising a microprocessor and a programme memory containing at least one operating program, the method comprising:
generation of a set of unique computer codes called artificial computer codes; and
writing the set of unique computer codes in the program memory in specific memory locations.

9. Personalization method according to claim 8, wherein the security module receives a message comprising means to generate said set of artificial computer codes.

10. Personalization method according to claim 9, wherein the said message is received after the security module is powered on.

11. Personalization method according to claim 10, wherein the set of artificial computer codes is deleted from the memory of the security module when this security module is powered off.

12. Personalization method according to claim 9, wherein the means for generating said set of artificial computer codes comprises an algorithm.

13. Personalization method according to claim 12, wherein the artificial computer codes are generated by using said algorithm applied on data pertaining to the security module.

14. Personalization method according to claim 8, wherein the artificial computer codes arranged in said specific memory locations are not executed by said microprocessor.

15. Personalization method according to claim 8, wherein the artificial computer codes arranged in said specific memory locations have no influence on the execution by said microprocessor of the operating program.

16. Personalization method according to claim 8, wherein said artificial computer codes forming said unique set are selected from among a computer code library.

17. Personalization method according to claim 8, wherein said artificial computer codes form an instruction block different from the computer codes making up the operating program.

18. Personalization method according to claim 8, wherein said artificial computer codes are dispersed among the computer codes constituting the operating program.

19. Personalization method according to claim 8, wherein the computer codes are processed in such a way as to conceal the structure of the program formed with these codes.

20. Identification method of a security module comprising a microprocessor, a program memory containing at least one operating program and a unique identifier of said module, the unique identifier being constituted by a set of artificial computer codes executable by said microprocessor of the module and stored in the program memory, and in which computer codes have been made accessible to the public, this method comprising:
extracting the artificial computer codes from among the computer codes made accessible to the public;
processing of said artificial computer codes according to preset rules to deduce the unique identifier of said security module.
